(19) United States
(12) Patent Application Publication
(10) Pub. No.: US 2009/0086079 A1
(43) Pub. Date: Apr. 2, 2009

(54) CCD TYPE SOLID-STATE IMAGING DEVICE

(76) Inventor: Mitsuru IWATA, Odawara-shi (JP)

Correspondence Address: BIRCH STEWART KOLASCH & BIRCH, PO BOX 747, FALLS CHURCH, VA, 22040-0747, US

(21) Appl. No.: 12/238,170

(22) Filed: Sep. 25, 2008

(30) Foreign Application Priority Data
Sep. 28, 2007 (JP) P2007-256229

(51) Int. Cl. H04N 5/335

(52) U.S. Cl. 348/311; 348/E05.091

(57) ABSTRACT

A CCD type solid-state imaging device includes plural pixels 2 that are arranged and formed on a semiconductor substrate in a two-dimensional array, plural vertical charge transfer paths 3 each of which extends along a corresponding pixel column formed of the pixels 2, and a horizontal charge transfer path 4 that is formed along end portions, in a transfer direction, of the vertical charge transfer paths 3. A physical structure of the horizontal charge transfer path 4 is such a large capacity structure that a signal charge having an amount larger than a maximum amount of a signal charge transferred by each vertical charge transfer path 3 can be transferred.

### CROSS-REFERENCE TO RELATED APPLICATIONS

This application is based upon and claims the benefit of priority from the Japanese Patent Application No. 2007-256229 filed on Sep. 28, 2007, the entire contents of which are incorporated herein by reference.

### BACKGROUND OF THE INVENTION

1. Technical Field

The invention relates to a CCD type solid-state imaging device that combines signal charges from plural pixels and reads the mixed signal charges, and more particularly relates to a CCD type solid-state imaging device having a configuration in which blooming does not occur.

2. Description of the Related Art

In a CCD (Charge Coupled Device) type imaging device, for example, when an AE (automatic exposure)/AF (automatic focusing) process for a dark scene is carried out, an amount of a detected charge of each pixel is very small. Therefore, a signal is read out by combining signal charges from plural pixels. For example, signal charges from four pixels are combined and detected, and using this combined signal charge makes it possible to perform the AF process with a high sensitivity and perform the AF process at a high speed.

During this pixel combining and reading operation, an OFD (overflow drain) voltage applied to a semiconductor substrate of the solid-state imaging device may be adjusted as disclosed in JP 2001-257940 A (corresponding to US 2006/0256206 A and U.S. Pat. No. 7,102,680). For example, when signal charges from plural pixels are combined and read, the OFD voltage is adjusted to restrict an amount of saturated charge of each photodiode (pixel) to about ¼ of an amount of a saturated charge at the time of an ordinary imaging operation, and signal charges read from the pixels are combined on an charge transfer path. The above-described operation is premised on that, since an amount of an original signal charge is small during the pixel combining and reading operation, even if the amount of the signal charge is restricted to about ¼, no problem would arise.

However, in the solid-state imaging device, which is premised on that the OFD voltage is adjusted during the pixel mixing and reading operation, when a subject having a high luminance is present in a dark scene, signal charges overflow on the charge transfer path during the pixel mixing to cause a blooming.

### SUMMARY OF THE INVENTION

The invention provides a CCD type solid-state imaging device having a configuration that can prevent blooming from occurring during the pixel mixing even if the size of the imaging device is reduced in order to advance an increase of the number of pixels.

According to an aspect of the invention, a CCD type solid-state imaging device includes a plurality of pixels, a plurality of vertical charge transfer paths and a horizontal charge transfer path. The pixels are formed and arranged on a semiconductor substrate in a two-dimensional array. Each of the vertical charge transfer paths extends along a corresponding pixel column formed of the plurality of pixels. The horizontal charge transfer path is formed along end portions, in a vertical transfer direction, of the vertical charge transfer paths. The horizontal charge transfer path has a physical structure in which a signal charge having an amount larger than a maximum amount of a signal charge transferred by each vertical charge transfer path can be transferred.

Also, the physical structure of the horizontal charge transfer path may determine a transfer capacity of the horizontal charge transfer path. A physical structure of each vertical charge transfer path may determine a transfer capacity of each vertical charge transfer path.

The CCD type solid-state imaging device may further include a charge temporarily storing section that is provided between the end portions, in the vertical transfer direction, of the vertical charge transfer paths and the horizontal charge transfer path. The charge temporarily storing section may have a buffer area corresponding to each vertical charge transfer path. The charge temporarily storing section may temporarily store the signal charge transferred by each vertical charge transfer path in the corresponding buffer area, and transfer the temporarily stored signal charges to the horizontal charge transfer path. A capacity of each buffer area may be an intermediate capacity between a transfer capacity of the horizontal charge transfer path and a transfer capacity of the corresponding vertical charge transfer path.

Also, the horizontal charge transfer path may be configured to be able to transfer the signal charge having the amount being equal to an integer multiple of the maximum amount of the signal charge transferred by each vertical charge transfer path.

Also, assuming that the transfer capacity of the vertical charge transfer path is equal to 1, the capacity of the buffer area may be equal to 2 and the transfer capacity of the horizontal charge transfer path may be equal to 4.

The CCD type solid-state imaging device may further include a horizontal drain and potential barriers. The horizontal drain is formed along the horizontal charge transfer path. The potential barriers are provided between the horizontal drain and the horizontal charge transfer path and are provided for all transfer stages of the horizontal charge transfer path. The potential barriers may be formed to be high an unevenness caused by a fabrication process.

Also, of the potential barriers, a potential barrier for a first stage of a portion, for transferring charges detected by an optical black portion, of the horizontal charge transfer path is formed to be lower than potential barriers for stages of the portion of the horizontal charge transfer path that are disposed on a downstream side of the first stage in a horizontal transfer direction.

According to another aspect of the invention, a CCD type solid-state imaging device includes a plurality of pixels, a plurality of vertical charge transfer paths, a horizontal charge transfer path, a light shield member, a horizontal drain and potential barriers. The pixels are formed and arranged on a semiconductor substrate in a two-dimensional array. Each of the vertical charge transfer paths extends along a corresponding pixel column formed of the plurality of pixels. The horizontal charge transfer path that is formed along end portions, in a vertical transfer direction, of the vertical charge transfer paths. The light shield member that divides the pixels into (i) pixels in an effective pixel area and (ii) pixels in an optical black portion provided on an upstream side in a horizontal transfer direction of the horizontal charge transfer path. The horizontal drain is formed along the horizontal charge transfer path. The potential barriers are provided between the horizontal drain and the horizontal charge transfer path and are provided for all transfer stages of the horizontal charge transfer path. Of the potential barriers, a potential barrier for a first stage of a portion, for transferring charges detected by the optical black portion, of the horizontal charge transfer path is formed to be lower than potential barriers for stages of the portion of the horizontal charge transfer path that are disposed on a downstream side of the first stage in the horizontal transfer direction.

According to the configuration set forth above, a blooming during the pixel mixing operation is suppressed due to the physical structure of the device itself. Furthermore, an absolute value of an amount of an obtained signal increases so that the sensitivity of a detected signal can be more improved, and the AF operation can be carried out at higher speed.

### BRIEF DESCRIPTION OF THE DRAWINGS

FIG. 1 is a schematic view of a surface of a CCD type solid-state imaging device according to a first embodiment of the invention.

FIG. 2 is a schematic view of a surface of a CCD type solid-state imaging device according to a second embodiment of the invention.

FIG. 3 is a schematic view of a surface of a CCD type solid-state imaging device according to a third embodiment of the invention.

### DETAILED DESCRIPTION OF EMBODIMENTS OF THE INVENTION

Now, embodiments of the invention will be described with reference to the accompanying drawings.

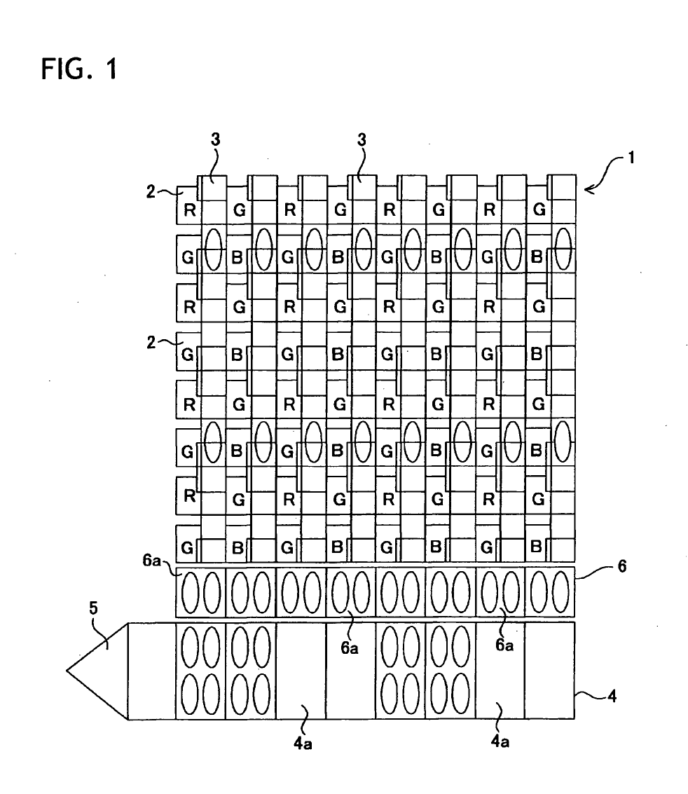

FIG. 1 is a schematic view of a surface of a CCD type solid-state imaging device according to a first embodiment of the invention. The CCD type solid-state imaging device 1 according to the first embodiment includes a plurality of photodiodes (pixels) 2 that are arranged and formed on the surface of a semiconductor substrate in a two-dimensional array. In this illustrated example, the plurality of pixels 2 are arranged and formed in a square grid, and color filters R (red), G (green) and B (blue) are provided thereon in the Bayer arrangement.

Vertical charge transfer paths (VCCD) 3 each of which extends along a corresponding pixel column are formed. Each vertical charge transfer path 3 is formed of an embedded channel formed in the semiconductor substrate and vertical transfer electrode films laminated thereon through a gate insulating layer. In the illustrated example, two transfer electrodes are provided for each pixel 2 (in FIG. 1, two squares illustrated on the right side of each pixel 2 represent the two transfer electrodes).

A horizontal charge transfer path (HCCD) 4 is provided along end portions, in a vertical transfer direction, of the vertical charge transfer paths 3. An amplifier 5 for outputting a voltage value signal corresponding to an amount of transferred signal charges is provided at an output end portion of the horizontal charge transfer path 4.

Similarly to the vertical charge transfer paths 3, the horizontal charge transfer path 4 is formed of an embedded channel and horizontal transfer electrodes laminated thereon through a gate insulating film. Potential packets 4a, which are formed by applying transfer pulses to the horizontal transfer electrodes, transfer the signal charges to the amplifier 5.

The above-described structure is similar to the structure of an ordinary CCD type solid-state imaging device. However, in the CCD type solid-state imaging device 1 of this embodiment, a line memory 6 (an example of a charge temporarily storing section) is provided along the horizontal charge transfer path 4 between the horizontal charge transfer path 4 and the vertical charge transfer paths 3.

As described in JP 2002-112119 A, the line memory 6 includes buffer areas 6a that correspond to the vertical charge transfer paths 3, respectively. The line memory 6 is provided to facilitate to perform the horizontal direction pixel mixing by temporarily receiving the signal charges transferred by the vertical charge transfer paths 3 in the buffer areas 6a and controlling a timing of transferring the temporarily stored signal charges to the horizontal charge transfer path 4 and a transferring timing of the horizontal charge transfer path 4. Also, there is a CCD type solid-state imaging device having no line memory 6, and the invention can be applied to such a CCD type solid-state imaging device.

In the description, the terms “vertical” and “horizontal” are used. However, those terms merely indicate meanings of “one direction” along the surface of the semiconductor substrate and a “direction substantially perpendicular to the one direction”.

Ellipses depicted on the vertical charge transfer paths 3, ellipses depicted on the line memory 6 and ellipses depicted on the horizontal charge transfer path 4 in FIG. 1 schematically show signal charges. One ellipse represents an amount of saturated charge of each pixel 2. For example, four elliptic forms are depicted in one transfer packet 4a of the horizontal charge transfer path 4. This represents that signal charges, which are read out from four pixels, respectively and each of which has a maximum charge amount (the amount of saturated charge), are accommodated in the packet 4a. Although the signal charges are mixed together in one packet 4a and are not separated into four, the four ellipses are schematically illustrated in a separated state to show that the four signal charges are accommodated therein.

In the CCD type solid-state imaging device 1 of this embodiment, when the pixels are combined, the OFD voltage is adjusted so that it is basically unnecessary to adjust and decrease the amount of saturated charge of each pixel 2. Therefore, a saturation capacity of charges in a place where signal charges from the pixels are combined is calculated, and the structure of the CCD type solid-state imaging device 1 of this embodiment is designed so that the signal charges don't overflow from the place where the signal charges from the pixels are combined.

In the CCD type solid-state imaging device 1, it is very difficult to increase a saturation capacity in an area (a pixel area) where the pixels (photodiodes PD) 2 are present. This is because if an area of each pixel 2 is increased to improve a sensitivity, it becomes necessary to decrease an area that the vertical charge transfer path 3 occupies correspondingly, so that the capacity of the vertical charge transfer path 3 is hardly increased.

Thus, in the CCD type solid-state imaging device 1 of this embodiment, the vertical charge transfer path 3 is formed to have a size (a capacity) so that transfer packets are formed in each of which can transfer an amount of saturated charge of the pixel 2.

However, the capacity of each place, where the signal charges from the pixels are combined, on the downstream side of the corresponding vertical charge transfer path 3 is designed to be larger than a maximum capacity of charges (namely, the amount of saturated charge of the pixel 2) transferred by the vertical charge transfer path 3. In the illustrated example, since two pixels are combined in each buffer area 6a of the line memory 6, the capacity of each buffer area 6a is designed to have a size (a capacity) so that each buffer area 6a can accommodate an amount of saturated charges of the two pixels.

Furthermore, the capacity of a place on the downstream side of the line memory 6 where the signal charges are combined is designed to be larger than the capacity of the buffer area 6a. In the illustrated example, since signal charges from four pixels are combined in each transfer packet 4a of the horizontal charge transfer path 4, the capacity of each place where the transfer packet 4a is formed is set to have a size that can accommodate an amount of the saturated charges of the four pixels.

The CCD type solid-state imaging device 1 is designed so as to satisfy the following relation

a≦b≦c<d

where

“a” denotes the capacity of the saturated charge of the photodiode 2

“b” denotes the transfer capacity of each vertical charge transfer path 3,

“c” denotes the capacity of each buffer area 6a of the line memory 6, and

“d” denotes the transfer capacity of the horizontal charge transfer path 4.

In the illustrated example, c=2b, and d=2c=4b. Also, it is difficult to form the pixels 2 so that the saturation capacities of the pixels are strictly the same. Therefore, even when, for example, the target structure satisfies a relation of d=4b, it is to be understood that the structure is actually designed while considering the relation of d=4b as the relation of “d=4b+an allowable error”.

In the CCD type solid-state imaging device of the related art in which the OFD voltage is adjusted to reduce respectively the amounts of the saturated charges of the pixels during the charge mixing process, it is not necessary to have the structure in which the capacity of each buffer area 6a of the line memory 6 and the capacity of each packet 4a of the horizontal charge transfer path 4 are increased.

However, in this embodiment, the capacity of the pixel mixing section on the downstream side of each vertical charge transfer path 3 is designed based on the amounts of the saturated charges, which are set when an image is captured using the respective pixels, so as to be equal to or larger than a sum of (i) the number of pixels to be mixed and (ii) the allowable error. Therefore, the amounts of the signal charges can be increased accordingly, and an output having a higher sensitivity can be obtained. Furthermore, even if an image of a high luminance subject is photographed, signal charges do not overflow. Thus, the blooming can be suppressed.

It becomes very difficult to increase the capacity of each vertical charge transfer path in the pixel area, as miniaturization of the pixels is further advanced. To the contrary, since there is enough space, it is easy to attempt to increase the capacity of the line memory and/or the capacity of the horizontal charge transfer path. Therefore, increase of the capacity of the line memory and/or increase of the capacity of the horizontal charge transfer path can be realized with increase of a production cost being suppressed.

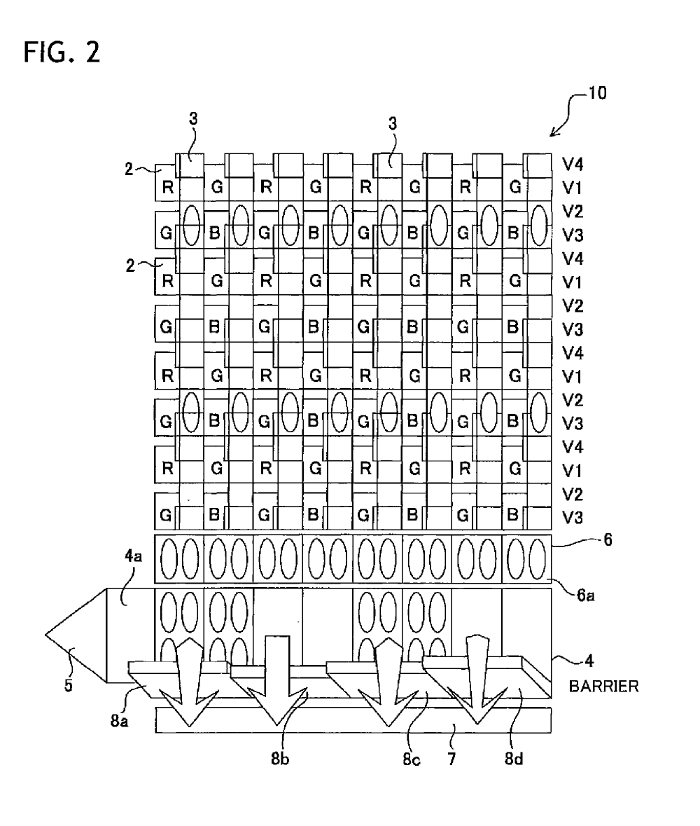

FIG. 2 is a schematic view of a surface of a CCD type solid-state imaging device 10 according to a second embodiment of the invention. The same members as those of the first embodiment shown in FIG. 1 are designated by the same reference numerals, and description thereon will be omitted. Different portions between the first and second embodiments will be described below.

In the CCD type solid-state imaging device 10 of this embodiment, a horizontal drain 7 is provided along the horizontal charge transfer path (HCCD) 4. Potential barrier parts 8a, 8b, . . . are provided between the horizontal drain 7 and the horizontal charge transfer path 4 and are provided for all transfer stages of the horizontal charge transfer path 4.

In the first embodiment shown in FIG. 1, if the capacities are designed with a good accuracy and if the respective elements are fabricated with a good accuracy, signal charges would not overflow from the potential packets. However, when an unevenness in fabrication (fabrication error) is taken into consideration, it is preferable to provide the horizontal drain 7 and the potential barriers 8a, 8b, . . . as in this embodiment. The height of each potential barrier determines a level at which excessive charges are swept to the horizontal drain 7.

In the illustrated example, the potential barrier 8b is lower than the other potential barriers 8a, 8c and 8d due to the unevenness in fabrication. It is assumed that the horizontal charge transfer path 4 transfers signal charges to the amplifier 5 along the potential barriers 8a to 8d while the respective potential packets are fully filled with the signal charges. In this case, an amount of signal charge that can pass through the potential barrier 8b is regulated by the potential barrier 8b, and charges larger than the potential barrier 8b are discarded to the horizontal drain 7 in the position of the potential barrier 8b.

Furthermore, the signal charges that only pass through the potential barrier 8a and do not pass through the potential barrier 8b are not discarded by the potential barrier 8b. Therefore, an amount of the signal charges, which only through the potential barrier 8a, are larger than amounts of signal charges, which are subsequent to the potential barrier 8a (and are transferred to the amplifier 5).

Namely, even if true signal charges (a value obtained by mixing the saturated charges of four pixels) in an upstream stage of the potential barrier 8b are increased or decreased in accordance with a captured image signal, since the true signal charges are regulated by the potential barrier 8b, the increase or decrease of the signal cannot be recognized. Furthermore, when an amount of signal charges in a downstream stage of the potential barrier 8b is larger than the amount of the charges regulated by the potential barrier 8b, since the signal charges are transferred to the amplifier 5 as they are, the signal corresponding to the downstream stage of the potential barrier 8b becomes excessively large.

If an image is formed in accordance with the captured image data with neglecting this phenomenon, horizontal luminance shading arises to deteriorate an image quality. Thus, when a signal processing circuit for processing output signals (the captured image data) of the CCD solid-state imaging device is provided with a function for neglecting parts of signals, which correspond to the unevenness and exceed the amount of saturated signal (a signal amount prescribed by the potential barrier 8b), to process such signals as saturated pixels, the image can be created without the horizontal luminance shading.

However, when such a process is carried out, the amount of saturated signal is regulated by the potential barrier 8b. Thus, in the CCD type solid-state imaging device 10 of this embodiment, when the potential barriers 8a, 8b, . . . are formed, the heights of the potential barriers 8a, 8b, . . . are designed and formed to be higher by the unevenness in fabrication. In such a way, the horizontal luminance shading can be avoided without depending on the above-described signal process.

When an image having a low luminance subject is captured by the CCD type solid-state imaging device 10, the number of times signal charges from pixels are combined on the horizontal charge transfer path 4 is not limited in principle. This is because even if a high luminance subject exists in a captured image so that signal charges overflow on the horizontal charge transfer path, such signal charges override the potential barrier and are discarded to the horizontal drain 7.

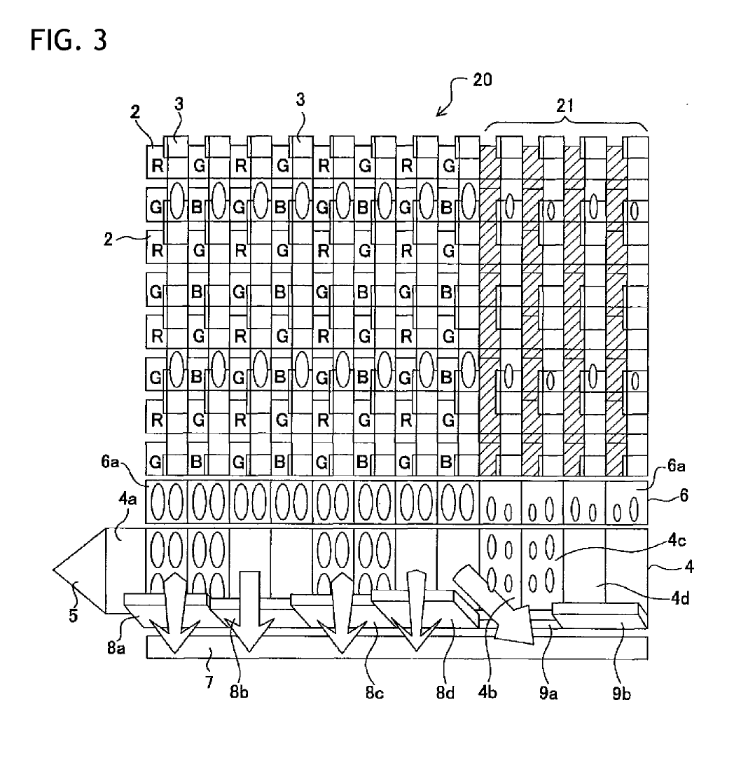

FIG. 3 is a schematic view of a surface of a CCD type solid-state imaging device 20 according to a third embodiment of the invention. The same members as those of the second embodiment shown in FIG. 2 are designated by the same reference numerals, and description thereon will be omitted. Different portions between the second embodiment and the third embodiment will be described below.

In the CCD type solid-state imaging device, an optical black (OB) portion which is optically covered by a light shield film is provided in a peripheral part of a light receiving area (an area where the pixels 2 and the vertical charge transfer paths 3 are provided), for example, on the right side of the light receiving area, that is, on an upstream side of the light receiving area in the horizontal transfer direction of the horizontal charge transfer path 4 in the illustrated example. An incident light to the OB portion is shielded, and a signal processing section of a post-stage processes captured picked signals with handling a signal level detected by the pixel of the OB portion as showing a “black level”.

In the CCD type solid-state imaging device 20 of this embodiment, potential barriers 9a and 9b are provided along an upstream stage portion, for transferring charges detected by the pixels of the OB portion 21, of the horizontal charge transfer path 4.

Even if the potential barriers 9a and 9b, . . . of the OB portion are formed to be lower than potential barriers 8a, 8b, . . . , of a portion for transferring signal charges detected by the pixels of the light receiving area, no problem would arise. In this embodiment, especially, the potential barrier 9a in the first stage of the OB portion is formed to be lower than the other potential barriers 9b, . . . .

That is, in this embodiment, the height of the potential barrier 9a located on the OB portion side of a boundary between the light receiving area and the OB portion is formed to be lower than those of the other potential barriers 9b, . . . , of the OB portion.

Since the signal detected by the pixel of the OB portion 21 is a signal detected by the pixel which is optically shielded, it is a signal used to detect a small and weak noise component such as a dark current. Therefore, it is not necessary to increase the transfer capacity of this portion. Thus, even if the potential barriers 9a, 9b, . . . , are formed to be low, no problem would arise.

On the other hand, if a high luminance subject is present, the signal charges detected by the pixels 2 of the light receiving area are increased. In that case, when signal charges from the pixels 2 are combined, the resultant signal charges are more increased, so that it is concerned that the resultant signal charges may overflow. If the overflowing signal charges cause an HCCD blooming to flow into a potential packet 4b of the horizontal charge transfer path 4 for transferring the detected signals of the OB portion 21, it would be difficult to detect the black level with high accuracy.

Thus, in the CCD type solid-state imaging device 20 of this embodiment, even if the HCCD blooming arises, the height of the potential barrier 9a is formed to be especially low in order to detect the black level with the high accuracy.

Thus, even when the signal charges overflowing in a previous stage flow into the potential packet 4b of the first stage of the horizontal charge transfer path 4 for transferring the detected signals of the OB portion 21, the signal charges simply pass the potential barrier 9a and are discarded to a horizontal drain 7 to prevent the signal charges from flowing into potential packets 4c, 4d, . . . , at next stages for transferring the detected signals of the OB portion 21.

Thus, the detected signals of the OB portion are not affected by the blooming and are transferred to the amplifier 5 by the horizontal charge transfer path 4, and an image is not damaged due to an error of an OB clamp.

In this case, when the signal of the packet 4b shown in FIG. 3 is used, since the excessive charges pass through the packet 4b and are discarded to the horizontal drain 7, the detecting accuracy of the black level is deteriorated. Accordingly, the signals of the packets 4c, 4d, . . . , at the next stages are used to determine the black level.

As described above, in the CCD type solid-state imaging device according to each of the embodiments, in place of a method in which the OFD voltage is adjusted so that the amounts of saturated charges of the pixels are reduced not to cause the blooming due to the signal charges during the pixel mixing operation, the line memory and/or the horizontal charge passage is designed to have a large capacity, and the physical structure thereof is designed to have a large capacity structure in order to deal with the blooming. Thus, the absolute value of an obtained signal amount becomes large. Therefore, the blooming can be suitably suppressed, and the high sensitivity and the high speed of an AE/AF operation can be more improved.

Even when the physical structure of the line memory and/or the horizontal charge transfer path is designed to have the large capacity, it is to be understood that the OFD voltage can be adjusted at the same time.

Furthermore, the structure of FIG. 3, namely, the structure that only the potential barrier 9a at the first stage provided in the OB portion is designed and fabricated to be lower than potential barriers 9b, . . . , at the post-stages so that the signal charges of the light receiving area are prevented from flowing into the detected signals of the OB portion can be applied not only to the CCD type solid-state imaging device of this embodiment in which the transfer capacities of the line memory and the horizontal charge transfer path are made to be larger than the transfer capacity of each vertical charge transfer path, but also directly to the CCD type solid-state imaging device of the related art in which the charge transfer path is not designed to have a large capacity. Thus, the HCCD blooming to the black level signal can be avoided.

In the CCD type solid-state imaging device in which the pixels are combined, the structure for avoiding the blooming is described above. However, this structure may be applied not only to the CCD type solid-state imaging device in which the pixels are arranged in the square grid described in FIG. 1, but also to a CCD type solid-state imaging device having a so-called honeycomb pixel arrangement in which pixels of odd numbered row are shifted by ½ pixel pitch with respect to pixels of even numbered rows (for example, a solid-state imaging device disclosed in JP Hei. 10-136391 A (corresponding to U.S. Pat. No. 6,236,434).

In the CCD type solid-state imaging device according to the exemplary embodiments, the blooming is suitably suppressed, and the high sensitivity and the high speed of the AE/AF operation can be achieved. Therefore, the CCD type solid-state imaging device according to any of the exemplary embodiments is available as a CCD type solid-state imaging device mounted on a digital camera.

What is claimed is:

1. A CCD type solid-state imaging device comprising:
a plurality of pixels that are formed and arranged on a semiconductor substrate in a two-dimensional array;
a plurality of vertical charge transfer paths each of which extends along a corresponding pixel column formed of the plurality of pixels; and
a horizontal charge transfer path that is formed along end portions, in a vertical transfer direction, of the vertical charge transfer paths, wherein
the horizontal charge transfer path has a physical structure in which a signal charge having an amount larger than a maximum amount of a signal charge transferred by each vertical charge transfer path can be transferred.

2. The CCD type solid-state imaging device according to claim 1, wherein
the physical structure of the horizontal charge transfer path determines a transfer capacity of the horizontal charge transfer path, and
a physical structure of each vertical charge transfer path determines a transfer capacity of each vertical charge transfer path.

3. The CCD type solid-state imaging device according to claim 2, further comprising:
a charge temporarily storing section that is provided between the end portions, in the vertical transfer direction, of the vertical charge transfer paths and the horizontal charge transfer path, wherein
the charge temporarily storing section has a buffer area corresponding to each vertical charge transfer path,
the charge temporarily storing section temporarily stores the signal charge transferred by each vertical charge transfer path in the corresponding buffer area, and transfers the temporarily stored signal charges to the horizontal charge transfer path, and
a capacity of each buffer area is an intermediate capacity between a transfer capacity of the horizontal charge transfer path and a transfer capacity of the corresponding vertical charge transfer path.

4. The CCD type solid-state imaging device according to claim 1, wherein the horizontal charge transfer path is configured to be able to transfer the signal charge having the amount being equal to an integer multiple of the maximum amount of the signal charge transferred by each vertical charge transfer path.

5. The CCD type solid-state imaging device according to claim 3, wherein assuming that that the transfer capacity of the vertical charge transfer path is equal to 1, the capacity of the buffer area is equal to 2 and the transfer capacity of the horizontal charge transfer path is equal to 4.

6. The CCD type solid-state imaging device according to claim 1, further comprising:
a horizontal drain that is formed along the horizontal charge transfer path; and
potential barriers that are provided between the horizontal drain and the horizontal charge transfer path and are provided for all transfer stages of the horizontal charge transfer path, wherein
the potential barriers are formed to be high an unevenness caused by a fabrication process.

7. The CCD type solid-state imaging device according to claim 6, wherein of the potential barriers, a potential barrier for a first stage of a portion, for transferring charges detected by an optical black portion, of the horizontal charge transfer path is formed to be lower than potential barriers for stages of the portion of the horizontal charge transfer path that are disposed on a downstream side of the first stage in a horizontal transfer direction.

8. A CCD type solid-state imaging device comprising:
a plurality of pixels that are formed and arranged on a semiconductor substrate in a two-dimensional array;
a plurality of vertical charge transfer paths each of which extends along a corresponding pixel column formed of the plurality of pixels;
a horizontal charge transfer path that is formed along end portions, in a vertical transfer direction, of the vertical charge transfer paths;
a light shield member that divides the pixels into (i) pixels in an effective pixel area and (ii) pixels in an optical black portion provided on an upstream side in a horizontal transfer direction of the horizontal charge transfer path;
a horizontal drain that is formed along the horizontal charge transfer path; and
potential barriers that are provided between the horizontal drain and the horizontal charge transfer path and are provided for all transfer stages of the horizontal charge transfer path, wherein
of the potential barriers, a potential barrier for a first stage of a portion, for transferring charges detected by the optical black portion, of the horizontal charge transfer path is formed to be lower than potential barriers for stages of the portion of the horizontal charge transfer path that are disposed on a downstream side of the first stage in the horizontal transfer direction.
